(19) United States
(12) Patent Application Publication
(10) Pub. No.: US 2025/0111837 A1
(43) Pub. Date: Apr. 3, 2025

(54) MODULAR DIGITAL CONTROL OF AUDIO ANALOG FUNCTIONS

(71) Applicant: Karno Sound Limited, London (GB)

(72) Inventors: Adam PIERCE, London (GB); George AINSCOUGH, London (GB); Ian STEELE, London (GB); Charles ENGLEBACK, London (GB)

(73) Assignee: Karno Sound Limited, London, EN (GB)

(21) Appl. No.: 18/723,585

(22) PCT Filed: May 18, 2023
(86) PCT No.: PCT/EP2023/063429

§ 371 Date: Jun. 24, 2024

(30) Foreign Application Priority Data
Jun. 7, 2022 (GB) 2208335.6

(51) Int. Cl. G10H 1/055; G10H 1/34

(52) U.S. Cl. CPC G10H 1/055; G10H 1/34; G10H 2250/101

(57) ABSTRACT

An audio signal processing apparatus comprises at least one controllable element 90, 91, 92 for performing an analogue audio processing function. The controllable element is operable with a digital controller 58 that controls the analogue audio processing function performed by the controllable element 90, 91, 92. At least one audio processing module 52, 54 comprises a partial audio processing circuit for an audio processing operation. The module 52, 54 is operable with the controllable element 90, 91, 92 to complete the audio processing circuit and thus to enable the audio processing operation. In this way the audio processing operation is controllable by the digital controller. A switching array 96 selectively couples audio processing modules 52, 54 and the controllable elements 90, 91, 92. A power supply 66 is operable to supply power selectively for audio processing circuit of the or each module 52, 54.

### FIELD

An audio signal processing apparatus; an audio processing module; an audio signal processing system; and a method of processing an analogue audio signal.

### BACKGROUND

Audio processing modules are used with various audio signal sources to apply sound effects to the audio. They are used in analogue synthesisers and audio mixers or mixing desks. They are used with electric guitars where they are known as fuzz boxes. Fuzz boxes are often used singularly. However, they can also be used in plural combination.

Fuzz boxes, and indeed other audio processing modules, are connected in series or parallel or a combination of both to achieve different sound effects. Fuzz boxes are sometimes placed on the stage ahead of a performance and have switches and dials large enough to be operated by foot during the performance. Modules are commonly placed in a rack when used in conjunction with analogue synthesisers, audio mixers, mixing desks and the like.

FIG. 1 is a schematic diagram of electrical elements in an analogue audio processing module 10. There are numerous different ways in which the electrical elements may be configured. The module 10 is shown in FIG. 1 as comprising an arbitrary selection of elements representative of what may be found in a typical module. The elements comprise an input connection 11, commonly a socket, coupled to an input stage or buffer 12.

The input connection 11 enables an audio signal source-say a microphone, a pickup in a guitar or an audio tape—to be coupled to provide an electrical signal as an analogue of speech or musical notes. Depending on the intended use of the module 10, the input stage 12 may serve to present a specified impedance at the input, to isolate the input from later elements in the module 10 or to condition the signal before further processing by the module.

Signals from the input stage 12 are passed to processing stage 14 which applies a transfer function fx that processes the signal to modify the audio represented thereby. The fx stage 14 may comprise such elements as an attenuator, a filter, a delay circuit, a pre-amplifier, a signal amp, a clipping amp or so on. Indeed, depending on the sophistication or complexity of the audio processing, the module 10 could include a combination of such elements (not shown) together applying the desired processing to the electrical audio signal supplied thereto.

In some modules, one or more control switches, dials or knobs 15 are provided to allow a user to alter the effects fx applied to the audio signal. In practice a rotary switch or dial is typically provided. Switches and dials allow the user to turn the module on or off, or to include or bypass circuit elements in the module (such as the fx stage 14) to change the processing effects on the input signal.

A knob 15 might be coupled to a potentiometer or similar element with variable impedance that can be used for example to attenuate a signal or control operation of a more active element such as a filter or an amplifier. Knobs are typically included for volume and tone control. But they are also used to modify the transfer function of filters to vary the effects applied to the analogue audio signal by the module 10.

Processed signals from the fx stage 14 are provided to an output stage or buffer 17 that operates in a similar manner to the input buffer 12, say, to match impedance or condition the signal to conform to a specified or expected range of output currents or voltages. A socket 19 allows the processing module 10 to be coupled to another module for further processing of the signal or to, say, a power amplifier that drives loudspeakers in an auditorium, theatre or other performance venue. The socket 19 may serve as a connection to a signal storage device, for example a tape recorder for long terms storage of the analogue audio signal.

FIG. 2 shows a processing module 20 comprising another arbitrary selection of elements. An audio signal is input at plug 21 coupled to an isolating transformer 22 which outputs signals for a preamplifier 23. Conditioned signals are applied to a filter 24 which changes the signal depending on the filter's characteristics and the position of a control knob 25 and outputs the modified signal for another output stage 27. For the sake of variety—and to illustrate that there is no fixed design for an analogue audio processing module—the output stage is shown as a variable preamplifier 27 that works with another isolating transformer 28 to output audio signals via a socket 29 for further processing, amplification or storage. Typically a preamp here would be controlled via a knob similar to the knob 15 in FIG. 1, but it need not be depending on, say, the intended use of the module 20.

The module 20 comprises a tap or connection 26 between the filter 24 and the preamplifier 27 which may be coupled via a lead (not shown) to provide feedback signals at the input 21 or feedforward signals at the output 29. This provides the user with further control over the effects applied by the module to the audio signal. Additional taps (not shown) may be provided between other stages in the module to provide further user control over the effects.

FIG. 3 shows a series of modules connected to each other with a feedback path 35 and a feedforward path 36 created by way of interconnections between taps 26 in the modules. This allows a user to modify the effects produced by a cascade of modules between input connection 37 and output connection 38. Taps may also be coupled to the inputs and outputs of the individual modules 32 to 34 or the input 37 or the output 38 of the cascade as desired. Couplings like this are used in analogue synthesisers (not shown) although they can be, and sometimes are, used in relation to mixing desks (not shown).

FIG. 4 shows an example of one way these processing modules are used in audio mixers in recording studios. In this situation, as illustrated in FIG. 4, a rack 40 is provided to house several processing modules 42 to 45. Where necessary, the rack 40 provides a common power supply (not shown) and settings in each module may be adjusted vis control knobs and switches 15 on the front of each module 42 to 45. Sockets 26, 29 provided on the front of some of the modules 43, 45 provide connections to inside the module, as per the tap 26 in FIG. 2. A similar configuration may also be used in relation to analogue synthesisers.

Analogue audio signal processing modules have been available in many and varied different forms for decades. As with all products, some models come and go while others remain popular for years. Analogue modules continue to be used widely despite the availability of digital equipment that serves essentially the same function.

More recently, but still measured in decades, digital signal processing has been adopted extensively in relation to audio signals. An analogue signal is converted into digital form by taking samples of the analogue signal at regular intervals. This results in a sequence of numbers representing the audio signal. The numbers are modified by digital signal processors to modify the audio represented thereby. In this way equivalent effects can be applied to the audio in the digital environment as in the analogue environment.

Indeed, many effects created by analogue processing modules-fuzz boxes and the like—are now available in the digital environment. In some situations, the effects of an analogue modules are emulated by a computer or digital signal processor. This is all well and good. It is consistent with the move of electrical-based audio technologies to the digital environment.

However, the equivalent digital effects are often said to lack the warmth and intimacy of their analogue originals. While this is subjective and difficult to quantify, it is nevertheless a real issue in the audio world. A digital version may be equivalent, but it is not the same as the analogue. Put simply, musicians, sound engineers and producers like the analogue modules because of the familiarity-many have been available for decades—their sound and their warmth (however that is quantified). A user knows what they are going to get from a given module.

Nevertheless it would be useful to be able to take advantage of digital control techniques when using audio processing modules. In a wholly analogue environment, where several modules are coupled together to achieve a particular sound effect, it is necessary to note how the modules are connected and what settings were supplied. Failing to do so makes it challenging to reproduce the same sound again in the future.

During a performance, making changes between one set of complex settings an another is time consuming. Simple changes—turning modules on or off, adjusting a few dials and switching a few connections—may be all that is possible between songs. A studio, naturally, has the luxury of being able to stop and reset all the equipment before continuing with a recording. But even here, wholly relying on notes to record various settings takes time to maintain current or up-to-date, adding to the cost of production.

### SUMMARY

The invention provides an audio signal processing apparatus; an audio processing module; an audio signal processing system; and a method of processing an analogue audio signal.

An audio signal processing system comprises: an audio signal processing apparatus comprising a digital controller and at least one controllable element for performing an analogue audio processing function, the controllable element being operable with the digital controller for control of the analogue audio processing function thereby; and an audio processing module comprising a partial audio processing circuit for an audio processing operation, the module being coupled with at least one controllable element to complete the audio processing circuit to enable the audio processing operation.

The invention is defined by the claims.

The above and further features of the invention are set forth with particularity in the claims and together with advantages of the invention should become clearer from consideration of the following description given with reference to the drawings.

### LIST OF DRAWINGS

FIG. 1 is a schematic diagram of electrical elements in an analogue audio processing module.

FIG. 2 shows in more detail a processing module comprising another arbitrary selection of elements.

FIG. 3 shows modules connected to each other in series with feedback paths and feedforward paths.

FIG. 4 shows an example of the use of plural processing modules in a rack.

FIG. 5 is a schematic diagram of an audio processing system with a control platform and analogue audio processing modules.

FIG. 6 shows an example of a graphical representation of modules for display on a user interface.

FIG. 7 shows details of a module suitable for use in the system of FIG. 5.

FIG. 8 shows the module of FIG. 7 coupled to a controllable element.

FIG. 9 shows the module of FIG. 7 coupled to two controllable elements.

FIG. 10 shows a module comprising a controllable element.

FIG. 11 shows elements of the platform in more detail.

FIG. 12 is a schematic diagram of a power supply.

FIG. 13 shows information and control paths in the system.

FIG. 14 shows movement of information within the system.

FIG. 15 is a schematic diagram of a controllable element.

FIG. 16 shows a switching matrix coupled with audio processing modules.

FIG. 17 shows the switching matrix coupling various elements in the system.

FIG. 18 represents one way in which modules and controllable elements could be coupled via the matrix.

FIG. 19 Illustrates data transfer to a user interface.

FIG. 20 Illustrates data transfer from a user interface.

FIG. 21 Illustrates data transfer to an audio workstation.

### DETAILED DESCRIPTION

FIG. 5 is a schematic diagram of an audio processing system 50 with a platform (PFM) 56 and analogue audio processing modules 52, 53, 54. The audio processing modules 52, 53, 54 are controlled and connected via the platform 56. Operation of the platform 56 is controlled by way of a central processor unit (CPU) 58 coupled to the platform via a digital bus 60 that is also coupled to each of the modules 52 to 54.

The CPU 58 is shown outside the platform PFM 56 to facilitate description and understanding. In practice it will usually be included as part of the PFM 56. The operations of the CPU 58 described in the following may be executed by a dedicated processor in the platform as shown. There is, however, no technical reason why the CPU may not be provided as a unit outside the platform. The operations may instead be performed by, say, a personal computer (not shown) coupled with the platform by way of the bus 60. Either way the operations are essentially the same.

The CPU 58 receives commands from a user interface (UI) 62 that enables a user to set operating parameters within each of the modules 52 to 54. The UI 62 may be provided e.g. by way of any of a mobile phone, a tablet, or a personal computer coupled to the CPU 58 via a suitable data connection 64, say USB Wi-Fi, Bluetooth or similar.

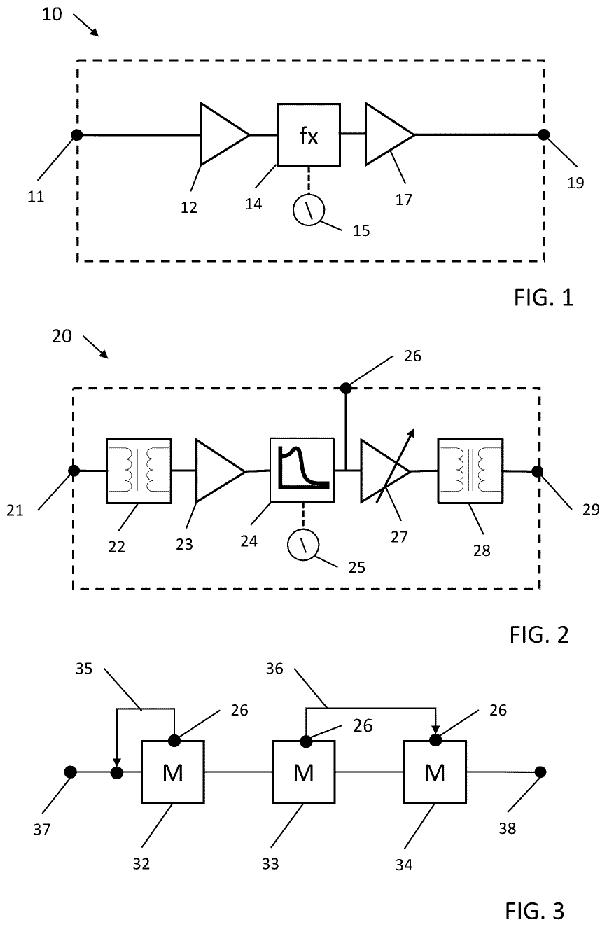

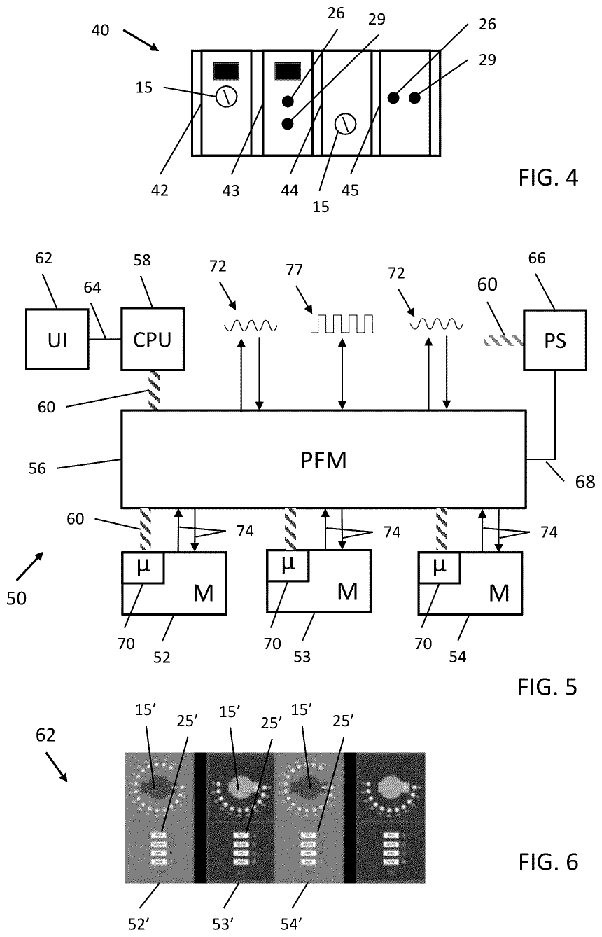

The user interface 62 provides a way for a user to input commands to the system 50. Typically the commands will be to adjust the operation of the modules 52, 53, 54 in a manner equivalent to adjusting the dials and knobs 15, 25 discussed with respect to FIGS. 1 to 4. While any form of representation may be used for the modules-including control input via a keyboard or mouse—it is now common to have a graphical representation displayed on a touch sensitive screen, such as found on a touch tablet device.

FIG. 6 shows an example of a displayed graphical representation of modules 52′, 53′, 54′ equivalent to the modules 52, 53, 54 in FIG. 5. Each module has a selector dial 15′ and other indicators 25′ equivalent to the knobs and dials discussed and shown in FIGS. 1, 2 and 4. A user may manipulate these visual input elements 15′, 25′ to change settings in the corresponding modules. The user interface UI 62 responds to this manipulation by generating control data for use by the CPU 58, as will be described in greater detail in below.

For reasons that should become clear later herein, the modules 52, 53, 54 may be designed directly from existing audio processing modules by their current manufacturers. Starting with the original module, the circuitry may be modified an adapted to make it suitable for use with the system 50. This allows popular and historical models to be included in the system, making its operation familiar to many users. Where this is done, the graphical representation displayed on the UI 62 may be a facsimile of the original module's front panel, with a representation of the same knobs, buttons and dials as on the original.

Returning to FIG. 5, the system 50 also comprises a power supply (PS) 66 supplying power to the system 50 via power line 68. While shown outside the platform for the sake of illustration, the power supply PS 66 will typically be included as part of the platform 56. The power supply 66 is coupled to the processor (CPU) 58 via the digital bus 60 and is controlled thereby. The power supply PS 66 provides power via supply lines (not shown in FIG. 5) to the various elements on the platform 56 and the modules 52, 54.

The platform (PFM) 56 contains a switching or coupling arrangement (not shown in FIG. 5) for coupling system analogue input and output lines 72 to module analogue lines 74. These analogue lines 72, 74 are shown as pairs in FIG. 5 but there is no significance in this beyond illustrating that analogue lines may be supplied individually or in groups of several lines as needs require. The analogue lines 72 provide points for audio signals to be input to the system 50, for example from a microphone or pickups in a musical instrument (not shown) and to be output from the system 50, for example to an amplifier (not shown).

The platform also comprises a digital audio port 77 for receiving and/or outputting audio signals in digital form. This enables the platform to receive signals from a digital source or to output digital signals to a digital destination. Thus, for example the system is able to convert incoming digital to analogue, pass the analogue through the modules 52, 53, 54, before outputting the resulting processed signal in digital form.

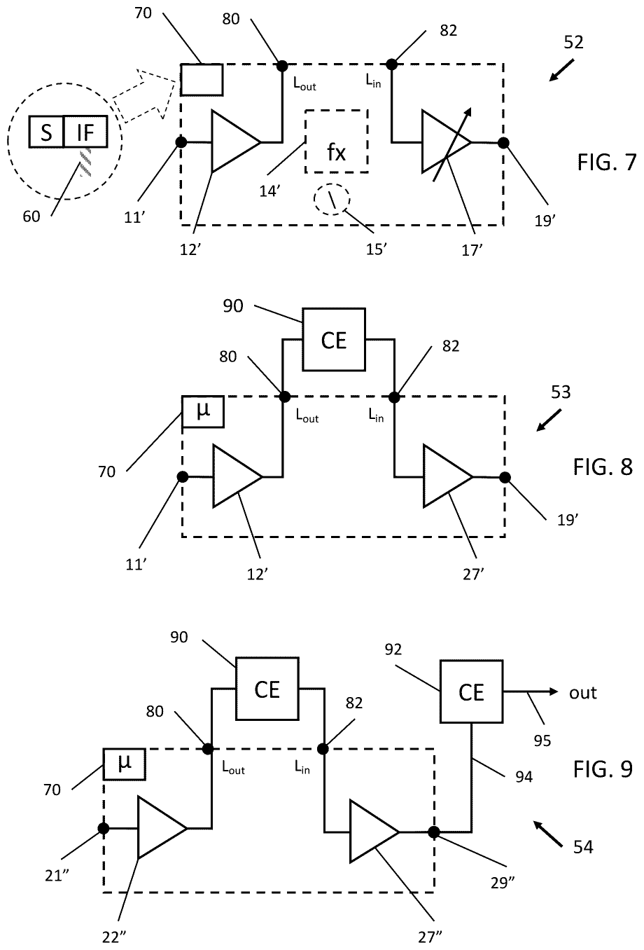

FIGS. 7, 8 and 9 shows details of modules 52, 53, 54 suitable for use in the system 50. The modules 52 to 54 are analogue devices, with much in common with the above-described modules 10, 20 shown in FIGS. 1 and 2. Indeed, where the modules are based on original analogue designs adapted for use with the system, they effectively retain access to popular designs from the past. A module, e.g. module 52, still comprises an input connector 11′ coupled to an input stage 12′ and an output stage 17′-here a variable amplifier-coupled to an output connector or socket 19′.

Each module 52 to 54 has an information store or data element 70 coupled to the platform 56 via the digital bus 60, and thus to the CPU 58. The data element 70 holds operational information that characterises operation of the module. The operational information is used initially to set up the way in which the module is connected with the platform and to define the ways in which the modules and the platform interact in use.

The operational information therefore includes characteristics or functionality of the part or parts of the module that have been removed and required characteristics of the controllable element CE 90, 92 that will replace them. Depending on the specifics of a module, the information may include the impedances of the input 21′, 21″ and the output 29′, 29″ to ensure signal balance between modules; signal voltage levels; and power supply requirements. Broadly speaking the information contains whatever is necessary to configure the controllable element CE to operate with the module.

This information is held in digital form. To this end, as shown in the detail at the top left of FIG. 7, the information store or data element 70 includes a memory store(S) and digital interface circuitry (IF) that interfaces to the bus 60 shown in FIG. 5. This enables the platform, including the CPU 58, to access the operational information to and to work accordingly. The digital interface circuitry IF may be a dedicated interface circuit. However, in practice it is convenient to provide a programmable controller configured to communicate with the CPU 58 via the digital bus 60. And thus to operate as the data element 70.

Microcontrollers (u) generally comprise a memory for storing applications, programs routines and for holding operational data. When a module is designed, data defining various characteristics of the module are held in the microcontroller's memory which data enables the module to be coupled to the platform and to work therein as intended by the designer.

A small microprocessor or a microcontroller (u) 70 is thus a suitable way implementing the memory S and interface IF. Depending on implementation details, a microcontroller u will often provide an efficient way of enabling the module to communicate with the CPU 58, and other parts of the platform 56 and thus to work in it as part of the system 50. Naturally, a separate memory could be used alongside or in place of the microcontroller's memory as a matter of design preference. In the following it is assumed that the information store or data element 70 comprises a microcontroller u, but it should be kept in mind that this is a matter of design choice.

As shown in FIG. 7, the processing stage fx 14′ and control knob 15′ have been removed from the module 52. This is represented by the broken lines. In place of these elements are terminals 80, 82 to which internal connect lines Lₒᵤₜ from the input stage 12′ and Lᵢₙ to the output stage 17′ are coupled. As can be seen these internal connect lines Lₒᵤₜ and Lᵢₙ are similar to the taps 26 connecting to the internals of the modules in FIGS. 2 and 3. Thus, some of the internals (fx) of the module 52 have been removed and access to the remaining parts of the module enabled by way of the internal connect terminals Lₒᵤₜ and Lᵢₙ 80, 82. Thus, the modules 52, 53, 54 comprise a partial audio processing circuit for an audio processing operation.

In practice the platform will typically include a mount such as a rack to which modules 52, 53, 54 can be removably mounted. Connectors on the modules corresponding to the terminals 11′, 19′, 80, 82 as shown in FIG. 7 connect with corresponding connectors in the rack to couple the electronics in the rack and the modules to one another.

In FIG. 8 the module 53 is shown coupled via the terminals 80, 82 to a controllable element CE 90. This coupling is done via the aforementioned connect lines Lₒᵤₜ and Lᵢₙ. The controllable element CE 90 is not part of the module 52, it is provided in the platform PFM 56 and will be described in detail below. As a matter of design choice, the controllable element CE 90 may be controlled by the processor CPU 58 or the information store 70 or both. Where the information store is implemented as microcontroller μ 70 it is convenient to place the control with the u 70.

The CE 90 is configurable by the CPU 58 to perform the same analogue functions as the elements removed from the module, e.g. the processing stage fx 14′ and control knob 15′. As will be explained further below, the CE 90 comprises analogue components, equivalent to those removed from the module, controlled by the CPU 58 based on operational data for the relevant module from the microcontroller 70. Thus, the controllable element CE 90 completes the audio processing circuit of the module 52, 53, 54 and thereby enables the audio processing operation previously performed by the module to be performed by the remaining elements in the module in combination with the CE.

In FIG. 9 the variability of the output preamplifier 27″ (see FIG. 7) in module 54 has been moved to a second controllable element CE 92 at the output 29″ of the module 54. The output 29″ is coupled via line 94 to the second controllable element CE 92. The controllable element CE 92, like the controllable element 90, is in the platform 56 (see FIG. 5). The output (out) of the CE provides a path 95 for an output signal to other parts of the system or to an external coupling (not shown).

In each of the analogue audio processing modules 52 to 54 in FIGS. 7 to 9, some of the functionality, typically but not necessarily functions that are variable, are removed from the module and replaced by a connection 80, 82, 94 to a controllable element 90, 92 in the platform 56. The reasons for this should become clearer from the following description. Among other things this approach allows manufacturers of analogue modules to take their existing designs and modify them by removing selected parts in the module 52 (e.g. a processing stage fx 14) and providing connectors 80, 82, 94 in their place to couple with a suitably configured controllable element 90, 92.

As should become clear from the following description, placing the controllable element CE 90 outside the module and in the platform 56 provides flexibility in the use of the system 50. Module construction is simplified because at least some of the analogue functionality fx is removed from the module. During use of the system 50 one module can readily be replaced by another, with the operation of the relevant CE or CEs being adjusted depending on the needs of the newly added module. Costs are lower because the system only needs a few CEs in the platform, rather than one in each module.

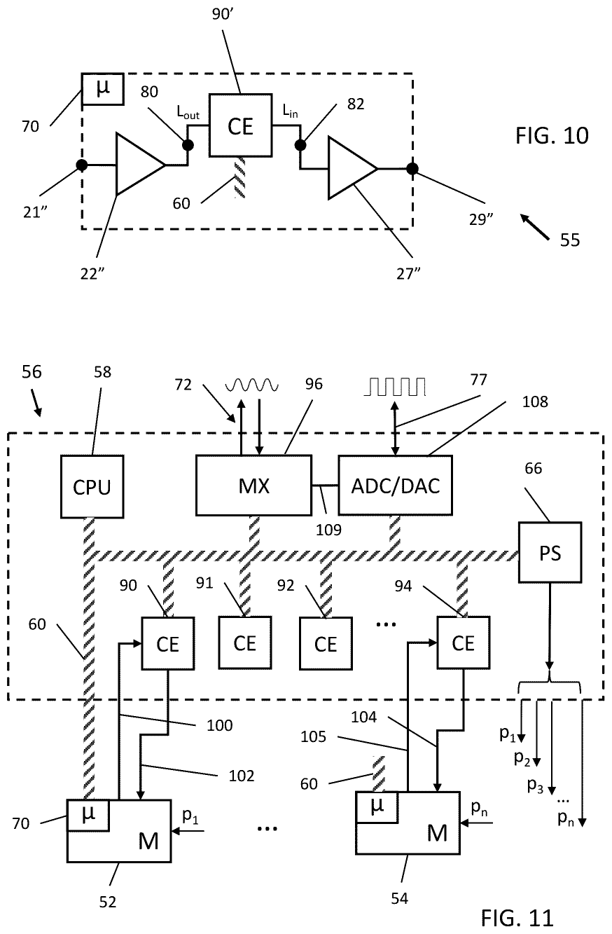

However, it is possible to place a controllable element CE 90 inside a module 55 as shown in FIG. 10. The elements in the module 55 in FIG. 10 are the same as those in the module 54 of FIG. 9 and are marked accordingly. The controllable element 90′ is coupled to the bus 60, either directly as shown or via the microcontroller u 70, and thus is controllable by the CPU 58.

This approach is advantageous for example where the module 55 serves a complex or highly specific function not readily performed by a general purpose controllable element CE. An equaliser providing separate attenuation across multiple frequency bands would require numerous filters, one per band, requiring a complex CE of limited appeal to many users. It would therefore be more cost-effective to use a CE specifically designed for that multiband functionality and to place it in or with the module 55. The benefits of digital control of the analogue function of the controllable element would still be realised, albeit without the same reduction in the cost of the module.

FIG. 11 shows the platform 56 is more detail. In this diagram the CPU 58 is shown as part of the platform, in contrast to how it is shown in FIG. 5. Similarly, the power supply unit PS 66 is contained within the platform 56. Here the bus 60 provides a path for control data between the CPU 58, the microprocessors (u) 70 in the modules 52, 54, the power supply PS 66, and controllable elements CE 90, 91, 92, 94, also in the platform.

The structure of the bus 60 is implementation-dependent and is influenced by such matters as design- and cost-effectiveness. While the bus 60 is shown as a unitary path in FIG. 11, it may in practice comprise plural different busses. There are many busses available suitable for system control and communication. The USB (Universal Serial Bus) standard is widely known, making it suitable for a system such as this where the platform may be made by one supplier and the modules by another supplier. USB hardware is broadly available, making it a cost-effective option of implementing the bus 60. The bus 60 thus may comprise a USB for communication of data between the CPU 58 and the microcontrollers 70.

Naturally other bus standards are available and may be more suitable for the transfer of control data. Where the CPU is provided by an externally connected personal computer, or the like, the external computer will usually be connected via an external bus such as ethernet or USB.

The controlled element CE 90, 91, 92 has a unique identifier, e.g. an address, which enables it to be identified by the system control CPU 58. It is therefore convenient from a design perspective to use a bus based on the serial peripheral interface (SPI) bus standard to transfer information between the CPU 58 and the CEs 90, 91, 92, 94. Many microcontrollers include GPIO pins (general purpose input output) that provide a logical 1 or 0 output that can be used to control directly on/off-type operations performed by the controlled elements. This is done in the system shown in the drawings and will be discussed further below.

Since the use of specific busses is an implementation detail, this description will generally refer to the bus 60 in a generic sense. Specific busses will be identified for their suitability where context requires or permits.

The number of modules 52, 54 in the system is a matter of design choice determined, among other things by user needs, including the user's desired processing capability, and budget. From a technical perspective it would be perfectly acceptable to provide a system 50 comprising only a single module 52 coupled to the platform PFM 56, although such a system might not take advantage of all the features a multi-module system.

An entry level system could be made available comprising, say, two or three modules 52, 54 mounted in a platform together with an appropriate number of controllable elements 90, 94. More may be included if desired, and the illustrated ellipsis ( . . . ) between modules 52 and 54 is intended to indicate that the system may be increased beyond the two modules shown in the diagram. These additional elements have been omitted for the sake of clarity in the drawing. Similarly, the ellipsis ( . . . ) between CE 92 and CE 94 indicates that the platform 56 may comprise further control elements (CE) depending on design-specific needs.

In larger systems, the platform and modules may be made and sold by separate suppliers. The platform would thus comprise a rack (not shown) into which individual modules could be mounted. Suitable connectors in the rack and the modules would provide the necessary connections to the data bus 60 and the various analogue lines for the module.

Still referring to FIG. 11, a switching array 96 controls the movement of analogue signals within the platform 56, to and from the modules 52, 54 and between the modules. The movement of analogue signal within the system is done by the switching array 96 along analogue lines, most of which are not shown in this FIG. 11. There are numerous analogue audio signal lines between the switching array 96 and the controllable elements 90 to 94. They too have been omitted for the sake of clarity in the diagram. They include the lines 100, 102 coupling the module 52 and the controllable element CE 90 and lines 104, 105 between the module 54 and CE 94.

The switching array 96 is identified in this FIG. 11 and in later drawings as a switching matrix MX. A matrix provides flexibility in coupling modules 52, 53, 54 and controllable elements 90, 91, 92 to each other. However, in some situations, say where the system is relatively small with only two or three modules, a matrix may not be an optimal solution. A simpler switching array may be more design- or cost-effective. Depending on implementation requirements, the switching array may be provided by CMOS analogue switches, multiplexers, relays, etc. as long as they are capable of routing signals between different inputs and outputs on the platform, the controllable elements and the modules. Nevertheless, for the sake of consistency and clarity, the remaining description is given with reference to a switching matrix MX.

Although the system is designed to maintain the audio signal in its analogue form—while providing for computer, i.e. digital, control—there may be times where a user wishes to receive audio from a digital source or to provide audio to a digital system. An analogue to digital and digital to analogue converter ADC/DAC 108 provides the path 77 for digital audio signals to be input to or output from the platform 56. The ADC and DAC is shown as a single unit, but may be provided as separate elements. However configured, ADC/DAC 108 are coupled to the bus 60 to enable control by the CPU 58. The analogue port of the ADC/DAC 108 is connected or coupled to the switching matrix 96 via an analogue line 109.

The power supply PS 66 delivers power to the platform 56 and the modules 52, 54 under the control of the CPU 58. In addition to supplying power to the platform and the microcontrollers 70 in the modules (the digital control part of the system) the power supply 66 also provides power separately and selectively to the analogue elements of the modules 52, 54. This is necessary because each manufacturer has, over many years, made their own decisions on the voltage levels within their devices—there is no uniformity.

The information stored in the microcontroller μ 70 therefore also specifies the power characteristics of the module. This includes such information as how much power the module needs and at what voltage. The information is used by the power supply 66 to supply power at the correct level via power lines p₁, p₂, p₃ . . . pₙ to the analogue circuitry in individual modules. This enables specific powering of the modules with required power levels, which is necessary if the system is to support modules of various different designs by different manufacturers.

Typically the power supply PS 66 is able to supply power over a range of voltages, say ±48 volts, with specific voltages being supplied depending on each module's individual requirements. It is possible some modules 52 to 54 may require voltages above the range of the power supply 66. Here, the design of the module would include a voltage booster to take the voltage available from the power supply and increase it to the level required by the analogue audio processing parts of the module.

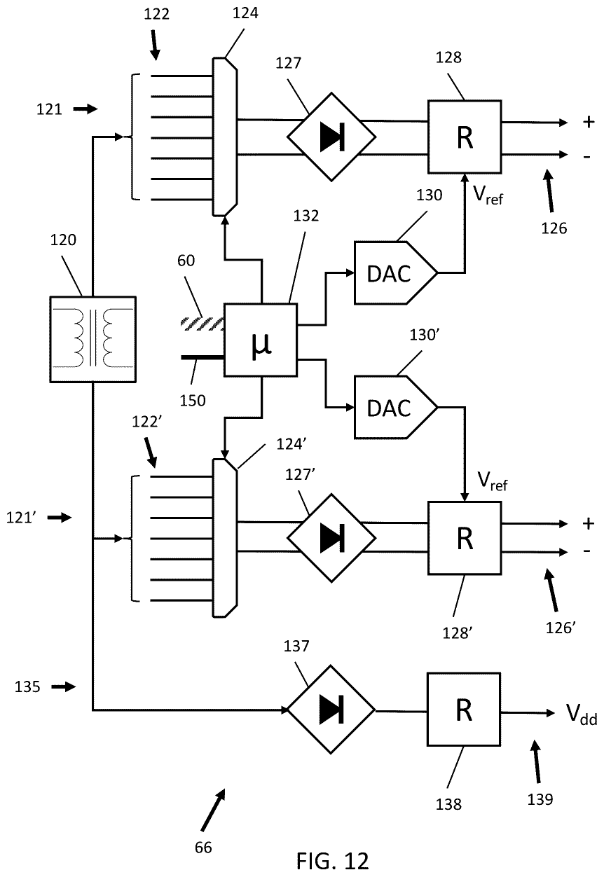

FIG. 12 shows the power supply 66 in greater detail. As shown, the power supply 66 comprises two power conversion paths 121 and 121′ coupled to receive an AC power signal from a multi-tap transformer 120 connectable to a mains power outlet (say 110-240V AC, not shown). The power supply 66 provides a separate power output for each controllable element CE 90, 91 (see FIG. 11) and thus comprises a separate power conditioning path 121, 121′ for each CE. However, in the interest of clarity, only two power paths 121, 121′ are shown. Both paths 121, 121′ will be described together since they operate in essentially the same manner.

Multiple taps 122, 122′ from the transformer 120 are provided to a multiplexer 124, 124′. Each tap provides a different AC power voltage to the multiplexer 124, 124′. Although the taps 122, 122′ are shown separately for each power conversion path 121, 121′, corresponding taps for each path will usually come from the same place in the transformer 120. The AC output from the multiplexer 124, 124′ is converted to a split rail DC supply 126, 126′ by a bridge rectifier 127, 127′ (or similar) and a regulator R 128, 128′ that receives a reference voltage Vref from a digital to analogue converter DAC 130, 130′.

Operation of the multiplexer 124, 124′ is controlled by a controller 132 which is connected to the bus 60 and receives control information from the control processor CPU 58 (see FIG. 11). Conveniently, a microcontroller μ—similar to the microcontroller 70 in the modules—is deployed as the controller 132. The controller u 132 provides a signal for the multiplexer 124, 124′ causing it to select one of the taps input thereto from the transformer 120. The controller u 132 also provides a signal for the DAC 130, 130′ causing it to output the reference voltage Vref for use by the regulator R 128, 128′.

The selection of the tap and the generation of the reference voltage Vref is determined by characteristic data for the module. This module data is static (it remains the same for the module in question) and is therefore stored in the module's microcontroller or associated store. As will be explained in greater detail herein below, static data such as this power requirement data is provided from the module to the CPU which passes it to the microcontroller μ 132 in the power supply. Thus, each DC supply 126, 126′ is generated at a level specified by information passed by the CPU 58 from the microcontroller for a given module 52, 54 (see FIG. 11).

Power is not initially supplied by the power conversion paths 121, 121′ to their respective modules. Before that can happen, the platform 56 must be powered together with the microcontrollers 70 in the modules, i.e. the digital parts of the system 50. This is necessary, among other things, so that information on the requirements of each module can be accessed from the modules 23, 54 used to set the output voltages to the required levels for the modules.

The power supply 66 therefore also comprises a further power conversion path 135 for providing power to the digital parts of the system 50, including the platform 56 and the parts of the module coupled to the platform by way of the bus 60, i.e. the microcontroller 70. The power conversion path 135 thus comprises a bridge rectifier 137 coupled to receive an AC power signal from the transformer 120 and a regulator 138 to provide a voltage V_{dd} for the digital parts of the system. This part of the power supply 66 provides an output when the system is switched on. It could, of course, be provided as a separate element when convenient to do so because the power it supplies is not dependent on modules plugged into or otherwise coupled with the platform.

Before moving on from FIG. 12, note that a second bus 150 is shown coupled to the controller μ 132. The purpose of this bus 150 is described below.

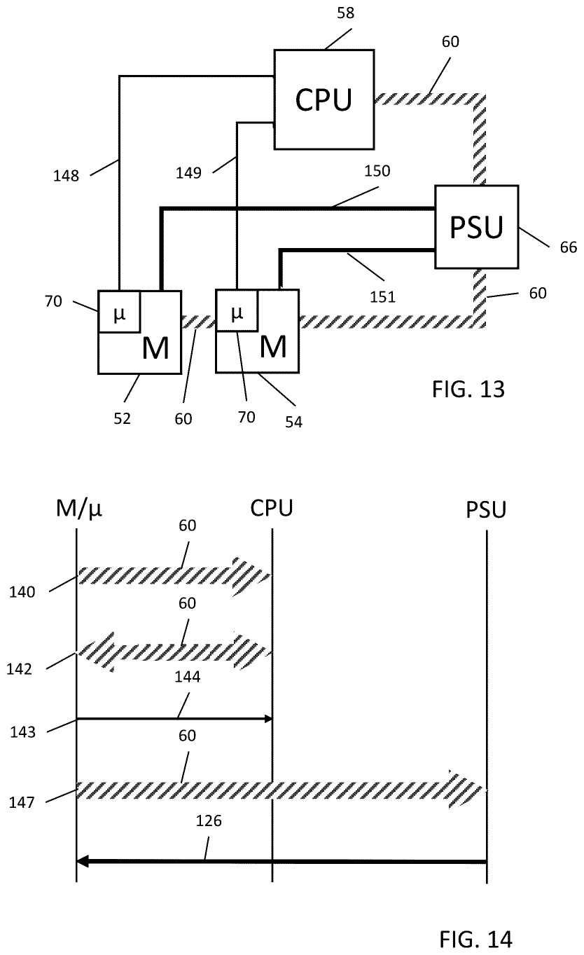

FIG. 13 shows how parts of the system, specifically the CPU 58, the PSU 66 and modules 52, 54, including the microcontrollers 70, are coupled with each other to enable power to be supplied to the modules. When the system is first turned on the analogue parts of the modules remain unpowered. Similarly, when a module is first added to a powered system, power will be applied to the microcontroller 70 but not to the analogue parts of the module.

The bus 60 is used for initial communication between the CPU 58 and the microcontrollers 70. As mentioned earlier in relation to FIG. 11, this communication may be provided by way of a USB bus. A USB bus is suitable for a system such as this where the platform (PFM in FIG. 5) may be made by one supplier and the modules by another supplier. USB hardware is broadly available, making it a cost-effective option of implementing the bus 60.

Referring to both FIG. 13 and FIG. 14, initial data 140 held in the store S (FIG. 7) of, or coupled with, the microcontroller μ 70 includes a ‘signature’ or ‘signed certificate’ in a known form that serves to identify the module. This signature data 140 is transferred to the CPU 58, via the bus 60. The CPU 58 verifies the signature in a handshake 142 between the microcontroller μ 70 in the module 52, 54 and the CPU 58 in the platform.

While the combined platform and modular design allows different manufacturers to contribute to the system, it also creates a risk that parts will be made that are not entirely compatible. Modules that don't work, that fail in short order or that physically damage the system risk reputational damage to the product and its supplier. The use of signatures facilitates quality control, making it less likely that poor quality equipment will be able damage the system.

Where modules are rack mounted, they may be placed anywhere in the rack. Once the initial system data has been verified by the CPU 58 the handshake 140 ends with the CPU 58 sending an instruction to the microcontroller μ 70 to provide a signal identifying its location in the system 50. This could be done via the USB bus 60. There is however a simpler approach.

As mentioned in relation to FIG. 11, microcontrollers typically include GPIO pins (general purpose input output). These pins are hardwired into connecting pins in the backplane of the rack mount. When the microcontroller 70 receives a command to send an identifying signal, it does so by placing a signal (say logical 1) on the relevant pin. This action is represented in FIG. 14 by the arrow 144 between the module M/u and the CPU. It is also represented by the lines 148, 149 in FIG. 13, coupling the microcontroller 70 in each module 52, 54 with the CPU 58. Thereafter, the microcontroller μ sends power requirement data 147 to the power supply PSU 66. This could, of course, be done via the bus 60. However, it need not be. The CPU 58 does not need to know this information, and passing it through the CPU is therefore unnecessary.

An alternative, as shown in FIGS. 12 and 13, is for the microcontroller μ to send the power requirement data directly to the PSU 66 via separate busses. An SPI (serial peripheral interface) bus 150, 151 couples the microcontrollers 52, 54 and the microcontroller 132 in the PSU 66, facilitating the transfer of the data. Note this is the bus mentioned toward the end of the description of FIG. 12 above.

The power data may be encrypted during transfer, providing, in addition to the signed certificate, another check the module is ‘legitimate’ in that its construction is known to be compatible with the system.

By the end of the exchange of information illustrated in FIG. 14 the power supply has all the information necessary to supply power at the correct level to each module 52, 54. Referring briefly again to FIG. 12, once confirmed, the microcontroller 132 in the PSU 66 uses the power requirement data to select the appropriate tap 122 via the multiplexer and to set the correct reference voltage Vref from the DAC 130 to drive the regulator R 128. The appropriate power is output from the regulator via lines 126 (also shown in FIG. 14) to the module 52, thereby energising the analogue elements of the module.

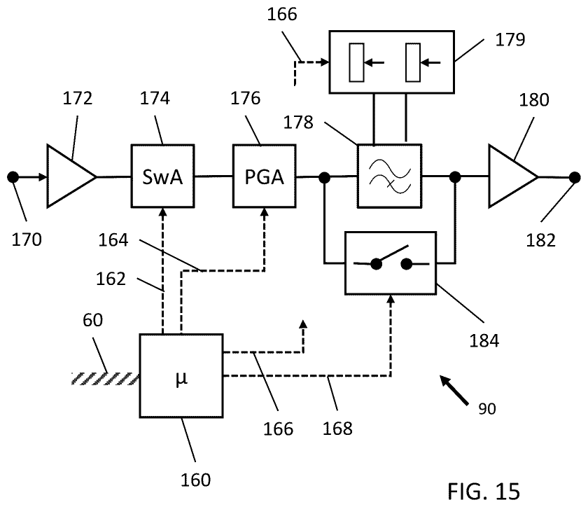

FIG. 15 shows a controllable element CE 90 in greater detail. Controllable elements are so designed that their function is adjustable to match the needs of a variety of individual modules 52. The controllable element 90 comprises a microcontroller 160 with a unique identifier, e.g. an address, which enables it to be identified by the system control CPU 58. The microcontroller 160 is coupled with the CPU via the (SPI) bus 60 and controls elements in the CE 90 by way of internal busses 162, 164, 166, 168.

While the bus 60 could be coupled to the elements in the CE 90 to enable control by the CPU 60, the use of a bus or busses internal to the CE 90 enables the CE to be self-contained. Among other things, this makes it easier for individual module companies to specify their own CEs for use in the system. As a matter of design choice, the bus internal to the CE is shown in FIG. 15 as these individual couplings 162, 164, 166, 168 between the microcontroller 160 and the various elements of the CE controlled by the microcontroller.

A signal from a module (e.g. connect lines Lₒᵤₜ and Lᵢₙ in FIG. 7) is input to the controlled element at coupling 170 and applied to the input of a fixed gain amplifier 172. The amplifier 172 buffers the signal, conditioning it into a form suitable for the CE. This is necessary for example where the signal levels from the module vary from one module to another. The conditioned signal is passed to a switched passive attenuator (SwA) 174 which provides signal attenuation from zero to high before the signal is passed to a programmable gain amplifier PGA 176.

A switched passive attenuator typically comprises an array of resistive attenuators (also known as pads) selectable individually or in combination to provide required attenuation of the signal. The switched passive attenuator 174 is controlled by the microcontroller 160 via bus 162. Where selection is limited to ‘on/off’ or ‘high/low’ a GPIO pin on the microcontroller is suitable for this. Where a range is available, a data bus such as an I2C bus (inter-integrated circuit) may be more suitable. The programmable gain amplifier PGA 176 is controlled by the microcontroller via bus 164, which is conveniently an I2C bus able to transfer data representing a range of different amplification values. This data is used to select the pads and thus control operation of the switched passive attenuator SwA 174.

The programmable gain amplifier PGA 176 provides variable gain control over a range, and its use in combination with the switched attenuator SwA 174 allows for variable gain over a wider range than would be possible with the PGA alone. When the microcontroller 160 receives operational data for the SwA 174 and PGA 176 from the CPU 58 over bus 60, it simply passes to the SwA and the PGA which operate accordingly. There are, naturally, numerous different ways in which a PGA may be constructed. No one programmable gain amplifier is preferable over another. The choice is simply a matter of meeting design criteria depending on the specifics of system.

The audio signal from the PGA 176 is applied to a filter 178, controlled by digital potentiometers 179 (also known as ‘digipots’). Typically digipots are CMOS based and consist of a serial string of resistors with digitally addressable electronic switches that serve as the wiper. The digipots are controlled by the microcontroller 160, via bus 166, a single bus shown as two separate parts simply to avoid cluttering the diagram. The bus 166 for the digipots 179, like the bus 164 for the PGA, is conveniently an I2C bus, which allows data representing a range of resistance values to be sent to the digital potentiometers 179. Again, the microcontroller 160 simply passes data it gets from the CPU to the digipots 179, which are set accordingly.

The filter 178 comprises plural filters, typically two separating high and low frequencies, with a corresponding digipot controlling the relative amplitude of each filter, and thus the frequency response characteristics of the filter 178. The filter 178 provides tone control. As with the PGA, there are, naturally, numerous different ways in which a filter may be constructed. No one filter is preferable over another. The choice is simply a matter of meeting design criteria depending on the specifics of system.

Although cost can be a factor, there is no technical reason why there could not be more filters and associated digipots providing frequency control of the signal over several frequency bins (ranges or bands of frequency). An alternative, as mentioned in relation to FIG. 10, would be for the designer of a module to place a CE inside the module to meet the specific needs of that module.

The filtered signal is applied to an output op amp 180, which functions to buffer the output before the signal is returned via coupling 182 to the module. A bypass switch 184 associated with the filter 178 is coupled to the microcontroller 160 via bus 168, which is conveniently a GPIO pin on the microcontroller 160. The switch 184, when closed, short circuits the filter 178, bypassing the tone control. This is useful where the design of the module requires no, or only minimal, change in frequency response. It may also improve audio quality by removing undesirable artefacts from, say, the digipots 179.

The foregoing description is of one example of a controlled element 90. It should be appreciated that other circuit configurations are possible and may indeed be desirable depending on the characteristics of the module 52, 54 that will be coupled to the CE 90. The CE shown in FIG. 15 is a voltage controlled and voltage sourcing device. Nevertheless, the CE and the module may be altered to accommodate current controlled/sourcing modules.

In a current-based circuit, placing a termination resistor at the output of the module provides a path for the output current, with the voltage drop across the resistor serving as the signal input to the CE 90. This termination resistor (not shown), together with the high dynamic range and low noise of the output buffer amplifier 180, maintains satisfactory audio quality of the signal passing through the CE. Moreover, the output buffer amplifier 180 has a known impedance and together with the input impedance of a current-controlled module, allows the correct output level to be calculated and set accordingly. And, provided the source has sufficient drive capability and the impedances are known, the input can be modelled in many current-controlled audio systems as a voltage input.

Other variations may also be desirable. A further bypass switch (not shown) could be provided where modules are used that do not require signal processing but merely a path coupling the modules connect lines Lₒᵤₜ and Lᵢₙ (see FIG. 7). This allow selective use of modules and may be useful for example where all that is required of a CE is to preserve a balanced output.

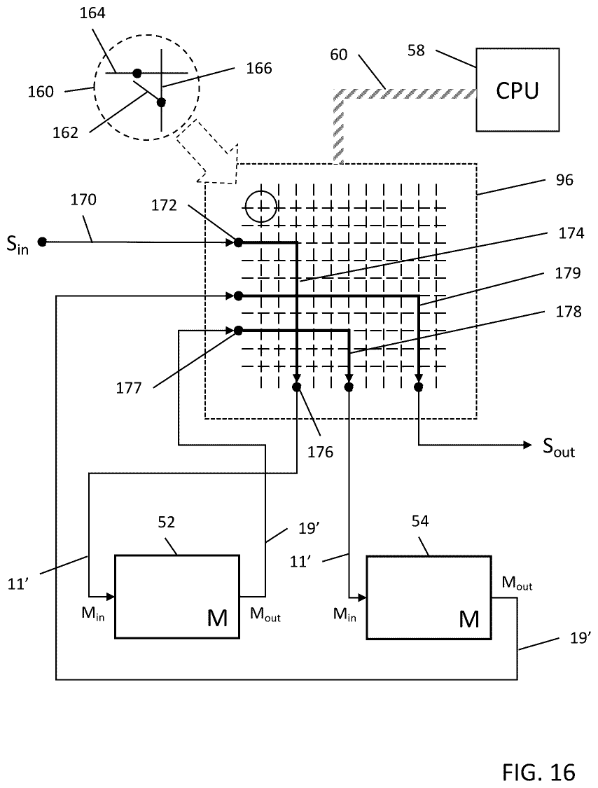

FIG. 16 shows the switching matrix MX 96 in more detail. The matrix 96 is shown conceptually as comprising an array of horizontal and vertical lines, a common representation of a switching matrix. These lines are connected as shown in the enlarged section view 160 by way of a switch 162. Closing the switch makes a connection between a horizontal line 164 and a vertical line 166. Operation of the switches 162 is controlled by the CPU. As mentioned above the matrix 96 need not be this complex. A simpler switching array may be more design- or cost-effective. Nevertheless, the switching matrix as shown will continue to be described in the following.

The switching matrix 96 is coupled with two modules 52, 54 via their inputs Mᵢₙ (equivalent to the connector 11′ in FIGS. 7 and 8) and outputs Mₒᵤₜ (equivalent to 19′). An input signal Sin is applied to line 170 connected to connection 172 in the matrix 96. Switches are closed or opened under command from the CPU 58 via the bus 60 to form a path 174 to connection 176.

The input to the module Mᵢₙ is coupled to the connection 176 by line 11′. Similarly, the output Mₒᵤₜ of module 52 is connected via line 19′ to connector 177 and the connection passes through the matrix along path 178 to connect with the input Mᵢₙ of the module 54. And the output Mₒᵤₜ of the module 54 passes via path 179 to an output from the system Sₒᵤₜ.

In other words, the input signal Sin is applied to the input Mᵢₙ of module 52. The output of the module 52 is coupled to the input Mᵢₙ of module 54. And the output Mₒᵤₜ from the module 54 is connected to the system output Sₒᵤₜ. This simple example of module linking shows how the matrix 96 is used in the system to connect modules to each other without the involvement of CEs.

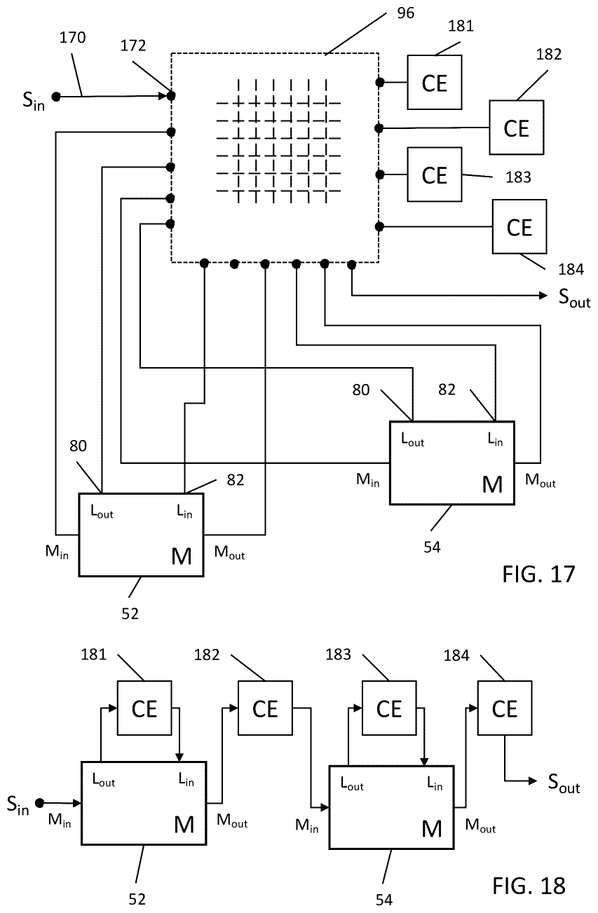

FIG. 17 shows the switching matrix 96 used to connect controllable elements CE and modules M to each other. An input signal Sin is again applied to line 170 connected to connection 172. Other lines to and from the modules 52, 54 shown in the diagram include internal connect lines Lₒᵤₜ 80 and Lᵢₙ 82. Several controllable elements CE 181 to 184 are shown connected to the matrix 96. However, internal paths in the matrix are not shown since doing so would add clutter. As already described in relation to FIG. 16, the CPU 58 activates switches 162 within the matrix to make the desired connections.

The controllable elements 181 to 184 are identified by location—where they are on the bus—with this information being available to the CPU 58. When a module 52, 54 is connected to the platform 56 the data sent to the CPU 58 is used by the CPU to configure the CEs 181-184 and to couple them with the relevant connectors (11′, 21′, 19′, 11″, 12″, 29″, 80, 82, see FIGS. 7 to 9) to form a complete circuit for the module.

One way in which the modules 52, 54 and the controllable elements 181 to 184 could be coupled via the matrix 96 is shown in FIG. 18. A controllable element CE 181 is coupled between the Lₒᵤₜ and Lᵢₙ connections of the first module 52. Typically this kind of connection would be made to replace internal functionality fx in the module 52 with a controllable element CE in the platform.

The output Mₒᵤₜ from the first module 52 passes through a controllable element 182 to the input Mᵢₙ of the second module 54. This could be done among other things to match characteristics, say impedance, of the output Mₒᵤₜ and input Mᵢₙ of the modules 52, 54. Controllable element 183 is connected in a similar manner to CE 181 and would again typically replace internal functionality in the second module 54. And CE 184, like CE 182 would perform conditioning of the signal-amplification, adjustment of dynamic range or VU levels, etc.—before it is output from the system at Sₒᵤₜ.

The module linking in FIG. 16 and the controllable element CE element connections in FIGS. 16 and 17 have been shown and described separately to avoid over-busy diagrams and to facilitate understanding. Naturally, these two types of connection can be done together. Furthermore, feedforward paths such as shown in FIG. 3—which paths may include controllable elements—are also readily achievable.

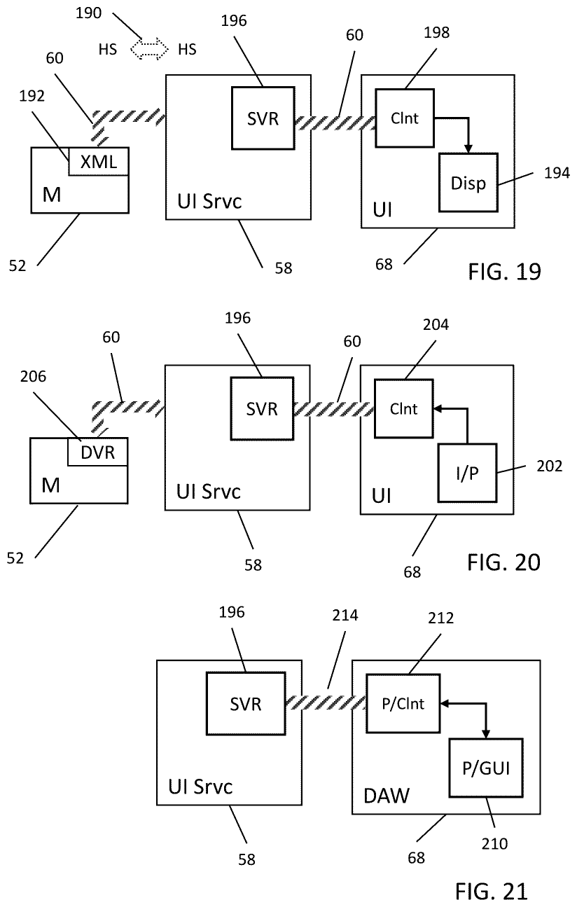

Turning to FIG. 19, the information transferred via bus 60 during the above mentioned handshake (HS) is represented, for the sake of completeness, by arrow 190 between HS on the module side and HS on the UI side. As already explained herein above, electrical data in an XML file is used by the CPU 58 to generate operation data for the power supply (FIGS. 11 to 13) and the controlled elements 90 (FIG. 15). Where there is module linking—two or more modules 52, 54 are coupled to each other as in FIG. 16—data from both or all modules is used by the CPU 58 to control the switching array 96 to establish the desired linking. Similarly, the manner in which modules 52, 54 and controllable elements CE 90, 91, 92 are coupled is contained within the XML file and is used by the CPU to establish the required coupling by the matrix 96.

In FIG. 19, user control is provided by way of the user interface UI 68 (see FIG. 5). The data from the module 52 also comprises an XML file 192 containing UI information defining graphics for display 194 by the UI. This includes characteristics of a graphical user interface for the module for display. While the graphics information from the module 52, 54 could provide a full definition of the graphical image of the module, it will usually be more efficient to store graphics for each module 52 in a library in the CPU 58. Indeed, the library could be stored in an online server (in the cloud) and accessed by the CPU 58 via an online connection (not shown) based on the data from each module.

The CPU 58 operates as a user interface service module UI Srvc including a web-like server SRV 196 arranged to generate graphics for a web client Clnt 198, e.g. a web browser. The web client 198 sends a web request to the web server 196 contained in the UI Srvc. The web-like server 196 responds with a web page that the web client 198 receives and uses to display a user interface on the display 194. The web page shows information about the installed modules 52, 54 e.g. their names, their physical positions, graphics corresponding to their branding, and their available controls. With graphics for the modules displayed on the UI 194, manipulation of the image enable a user to alter operation of the system.

It follows from the foregoing description of the CPU 58 and the UI 68 that the functionality of the CPU or the UI or both could be provided by a personal computer (not shown) coupled with the bus 60. Thus, the CPU 58 and UI 68 shown in the drawings may be implemented by way of a computer external to the system 10, consistent with what is described and shown in FIG. 5.

In FIG. 20 the UI 60 is shown as comprising a user input I/P 202. Where the display 194 has touch input capabilities, dragging and tapping the display serves as user input 202. In a PC-based arrangement the user input I/P 202 can be provided by a mouse (not shown) which drives a cursor on the display, with movement of the cursor and tapping and clicking serving as the user input. In both examples user manipulation of the image are interpreted by the user interface UI 68 as commands to alter operation of the system.

The commands are translated by a UI client Clnt 204 into a command web request which is sent to the web server 196. The UI Srvc in the CPU 58 translates the commands into operational data that is sent to a driver DVR 206 for the respective module 52 to alter its operation. The driver 206 is provided by the module's data element 70. Referring back to FIG. 15, the operational data is used by the module's microcontroller 160 to generate new data for the switched attenuator 174, the programmable gain amplifier 176, etc., thereby altering the module's operation.

In FIG. 21 the user interface 68 is provided by a digital audio workstation DAW running on a personal computer. Since the workstation is digital, audio data may be in digital form. Digital audio data can be transferred between the system and the DAW digitally by way of the analogue to digital converter ADC 108 shown in FIG. 11.

The UI 68 is provided as a plugin inside the digital audio workstation DAW. This plugin is the client software, and there will be a corresponding DAW plugin server running inside the UI service. The DAW plugin comprises a graphical user interface P/GUI 210 and a client P/Clnt 212, equivalent to the I/P 202 and Clnt 204 in FIG. 20. The DAW plugin P/Clnt 212 is coupled to the UI Srvc in the CPU 58 via a bus 214 which may be provided as an ethernet connection. The flow of commands between the DAW plugin P/Clnt 212 to the UI Srvc in the CPU 58 is analogous to that previously described with reference to FIGS. 18 and 19.

In summary, an audio signal processing apparatus comprises at least one controllable element 90, 91, 92 for performing an analogue audio processing function. The controllable element is operable with a digital controller 58 that controls the analogue audio processing function performed by the controllable element 90, 91, 92. At least one audio processing module 52, 54 comprises a partial audio processing circuit for an audio processing operation. The module 52, 54 is operable with the controllable element 90, 91, 92 to complete the audio processing circuit and thus to enable the audio processing operation. In this way the audio processing operation is controllable by the digital controller. A switching array 96 selectively couples audio processing modules 52, 54 and the controllable elements 90, 91, 92. A power supply 66 is operable to supply power selectively for audio processing circuit of the or each module 52, 54.

Having described the invention by reference to an audio signal processing apparatus, an audio processing module, an audio signal processing system, and a method of processing an analogue audio signal, it is to be understood that the same have been described by way of example only and that modifications and variations such as will occur to those possessed of appropriate knowledge and skills may be made without departure from the spirit and scope of the invention as set forth in the appended claims and equivalents thereof.

1. An audio signal processing apparatus comprising:
a digital controller; and
at least one controllable element for performing an analogue audio processing function, the controllable element being operable with the digital controller for control of the analogue audio processing function thereby and with an audio processing module comprising a partial audio processing circuit for an audio processing operation, to complete the audio processing circuit and thereby enable the audio processing operation.

2. An audio signal processing apparatus as claimed in claim 1, wherein the controllable element comprises a variable gain amplifier operable under digital control to vary the gain thereof, the amplifier being coupled with and responsive to commands from the digital controller to vary the gain.

3. An audio signal processing apparatus as claimed in claim 2, wherein the controllable element comprises an array of attenuators selectable individually or in combination to attenuate a signal, the array being coupled with the variable gain amplifier to pass an audio signal thereto and being coupled with and responsive to commands from the digital controller to vary the attenuation.

4. An audio signal processing apparatus as claimed in claim 1, wherein the controllable element comprises a variable filter for filtering signals in frequency ranges, the variable filter being operable to vary the filtering thereby.

5. An audio signal processing apparatus as claimed in claim 4, wherein the controllable element comprises one or more variable resistors coupled with the variable filter and operable under digital control to vary the resistance thereof, the variable resistors being coupled with and responsive to commands from the digital controller to vary the resistance and thus the filtering by the variable filter.

6. An audio signal processing apparatus as claimed in claim 4, wherein the filter has an input and an output, the controllable element comprising a switch coupled between the input and the output, the switch being coupled with and responsive to commands from the digital controller to bypass the variable filter.

7-10. (canceled)

11. An audio signal processing apparatus as claimed in claim 1, further comprising a switching array responsive to the digital controller for selectively coupling the or each audio processing module and the or each controllable element.

12. An audio signal processing apparatus as claimed in claim 1, wherein the digital controller is responsive to operational data from an audio processing module when coupled thereto to provide control data for the at least one controllable element.

13. (canceled)

14. An audio signal processing apparatus as claimed in claim 11, wherein the digital controller is responsive to operational data from an audio processing module when coupled thereto to provide control data for the switching array.

15. An audio signal processing apparatus as claimed in claim 1, further comprising a user interface coupled with the digital controller, the user interface being responsive to user manipulation to provide commands to the digital controller to vary operation of the controllable element or, as dependent on claim 11, the switching array.

16. An audio processing module for use with an apparatus as claim 1, the module comprising a partial audio processing circuit for an audio processing operation, the module being couplable with at least one controllable element to complete the audio processing circuit to enable the audio processing operation.

17. An audio processing module as claimed in claim 16, wherein the or each analogue audio processing module comprises a signal input for receiving an audio signal to be processed and a signal output for outputting a processed signal, the signal input being couplable to a signal source and the signal output being couplable to a signal destination.

18. An audio processing module as claimed in claim 16, wherein the or each analogue audio processing module comprises a data element for providing operational data for the audio processing module to the digital controller.

19. (canceled)

20. An audio processing module as claimed in claim 18, wherein the data element comprises a microcontroller having at least one input-output pin coupled with the controllable element for providing the control data to the controllable element.

21. An audio signal processing system comprising:
an audio signal processing apparatus comprising:
a digital controller;
at least one controllable element for performing an analogue audio processing function, the controllable element being operable with the digital controller for control of the analogue audio processing function thereby and with an audio processing module comprising a partial audio processing circuit for an audio processing operation, to complete the audio processing circuit and thereby enable the audio processing operation,
and
at least one audio processing module comprising a partial audio processing circuit for an audio processing operation, the module being couplable with at least one controllable element to complete the audio processing circuit to enable the audio processing operation.

22. A method of processing an analogue audio signal, the method comprising:
providing at least one controllable element for performing an analogue audio processing function;
providing at least one analogue audio processing module comprising a partial audio processing circuit for an audio processing operation;
using the at least one controllable element with the at least one analogue audio processing module to complete the audio processing circuit; and
controlling the analogue audio processing function of the controllable element to enable the audio processing operation of the at least one analogue audio processing module.

23. A method as claimed in claim 22, comprising providing a variable gain amplifier in the at least one controllable element and varying the gain thereof to vary the analogue function of the controllable element.

24. A method as claimed in claim 23, comprising:
providing an array of attenuators in the at least one controllable element coupled with the variable gain amplifier;
selecting attenuators in the array of attenuators individually or in combination to vary the analogue function of the controllable element.

25. A method as claimed in claim 23, comprising:
providing a variable filter for filtering a signal from the variable gain amplifier in frequency ranges;
varying operation of the variable filter to vary the analogue function of the controllable element.

26-29. (canceled)

30. A method as claimed in claim 22, further comprising:
providing a switching array; and
operating the switching array selectively to couple the or each audio processing module and the or each controllable element.
